(19) United States
(12) Patent Application Publication
(10) Pub. No.: US 2002/0145577 A1
(43) Pub. Date: Oct. 10, 2002

(54) Control circuit for preventing residual image in a liquid crystal display

(75) Inventors: Jizoo Lin, Hsinchu (TW); Jong-Ping Lee, Hsinchu (TW); Yung-Peng Hwang, Taipei (TW)

Correspondence Address: Richard P. Berg, Esq., c/o LADAS & PARRY, Suite 2100, 5670 Wilshire Boulevard, Los Angeles, CA, 90036-5679, US

(73) Assignee: Winbond Electronics Corp.

(21) Appl. No.: 09/948,529

(22) Filed: Sep. 7, 2001

(30) Foreign Application Priority Data
Apr. 10, 2001 (TW) 90108559

(51) Int. Cl. G09G 3/36

(52) U.S. Cl. 345/87

(57) ABSTRACT

A control circuit for eliminating residual image in an LCD includes: a detecting circuit, a comparator, a sub-control circuit, and a discharge circuit. When an LCD voltage generating circuit is turned on and the driving voltage of the circuit is built, the detecting circuit outputs an enable signal to the comparator, to compare a reference voltage and a threshold voltage. When the reference voltage is lower than the threshold voltage, the comparator outputs a data signal to the sub-control circuit. After receiving the data signals, the sub-control circuit outputs a control signal to the discharge circuit to release the charge stored in the at least one stable state capacitor of the LCD's voltage generating circuit, thus preventing the formation of residual image.

### BACKGROUND OF THE INVENTION

1. Field of the Invention

The present invention relates in general to a control circuit for a display. In particular, the present invention relates to a control circuit for preventing power off residual image for a liquid crystal display (LCD).

2. Description of the Related Art

The control circuit for a liquid crystal display (LCD) such as a super twist nematic (STN) type LCD generates a driving voltage (e.g. V₁, V₂, V₃, V₄ and V₅) The source voltage (V_{DD}), V₁, V₂, V₃, V₄ and V₅ change at different times, creating different levels of transparency, and thus the display of images. FIG. 2(a) is a conventional timing diagram of an LCD's driving voltage. In order to simplify the description, the figure only shows the positive and negative driving of the timing diagram of one pixel in the LCD. In FIG. 2(a), COM0 represents an output waveform of the first row voltage of the first pixel and SEG0 represents an output waveform of the first column voltage of the first pixel. The difference between COM0 and SEG0 (COM0-SEG0) is the output waveform of the first pixel. As mentioned above, a changing display is made possible by the changes in the voltage difference.

FIG. 2(b) and 2(c) show a plane view of an LCD 14 in accordance with FIG. 2(a) and a schematic view of the LCD's voltage generating circuit 12 with stable state capacitors 13. In FIG. 2 (b), the driving voltages (V₁, V₂, V₃, V₄, and V₅) of the pixel 15 maintain a stable output by using the stable state capacitors 13, as shown in FIG. 2(c). However, when source voltage (V_{DD}) is interrupted by twinkling or the LCD 14 is turned off, the control signal level between V_{DD} and V_{SS} is too low to work properly. The residual image appears in the LCD 14 due to remaining charge (V_{DD} to V₁, V₂, V₃, V₄ and V₅) in the capacitors 13, until the depletion of the charge. Since present-day LCD circuits normally utilize a low power design, the discharge rate is slow. Thus the problem of residual image has become more serious.

In a conventional LCD 14, the user turns off the display via a software command or hardware pin. That is, the charge in the capacitors 13 is depleted by a controlling circuit (not shown) controlled by the software or pin. It delays the time for turning off the LCD 14 or an extra pin is required.

Therefore, the present invention provides a control circuit preventing residual image for an LCD. When the source voltage drops to make the reference voltage lower than a threshold voltage (e.g. ground voltage), it releases the charge in the stable state capacitors by a discharge circuit to prevent the residual image effect.

### SUMMARY OF THE INVENTION

An object of the present invention is to provide an automatic control circuit for preventing residual image in an LCD power off period.

The control circuit includes: a detection circuit for an enabling the residue image circuit, whereby when an LCD's voltage generating circuit is turned on and the driving voltage of the circuit is built, outputting an enable signal; a comparator for inputting a reference voltage and a threshold voltage (e.g. ground potential) and receiving the enable signal to compare the two voltages, when the reference voltage is lower than the threshold voltage, outputting a data signal; a subcontrol circuit for receiving the enable signal and the data signal and then outputting a control signal; and a discharge circuit for receiving the control signal to shift the voltage level, and then providing a discharge path to release the charge stored in the at least one stable state capacitor of the LCD's voltage generating circuit.

### BRIEF DESCRIPTION OF THE DRAWINGS

The present invention can be more fully understood by reading the subsequent detailed description in conjunction with the examples and references made to the accompanying drawings, wherein:

FIG. 1 is a block diagram of a control circuit for preventing residual image in accordance with the embodiment of the present invention;

FIG. 2(a) is a conventional timing diagram of an LCD's driving voltage;

FIG. 2(b) is a plane view diagram showing an LCD in accordance with the FIG. 2(a);

FIG. 2(c) is a schematic view of the LCD's voltage generating circuit with the stable state capacitors in accordance with the FIG. 2(b).

### DETAILED DESCRIPTION OF THE PREFERRED EMBODIMENT

Power off residual image in an LCD is caused by charges in the capacitors not draining immediately. The present invention uses a detection circuit to detect the source voltage (V_{DD}) and provides a discharge circuit to release the charge from the stable state capacitors, thereby resolving the residual image effect.

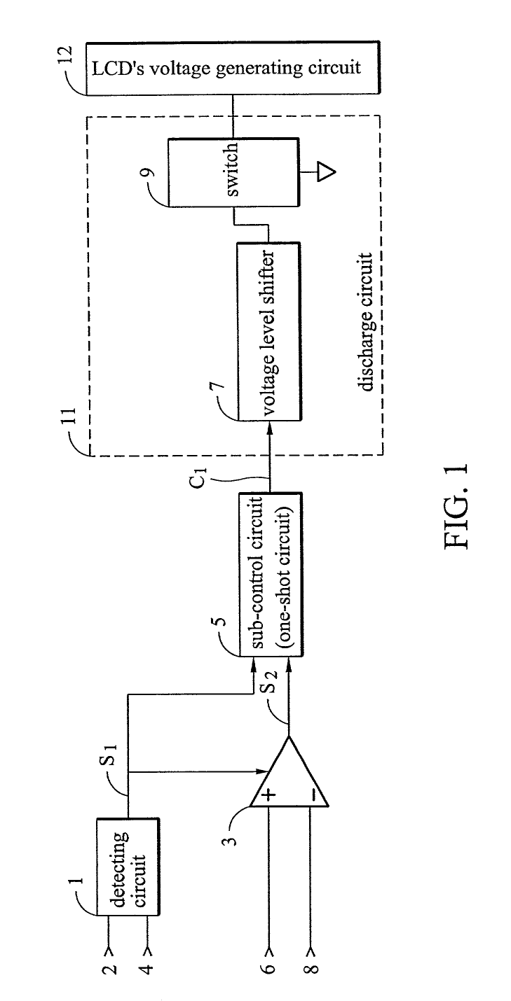

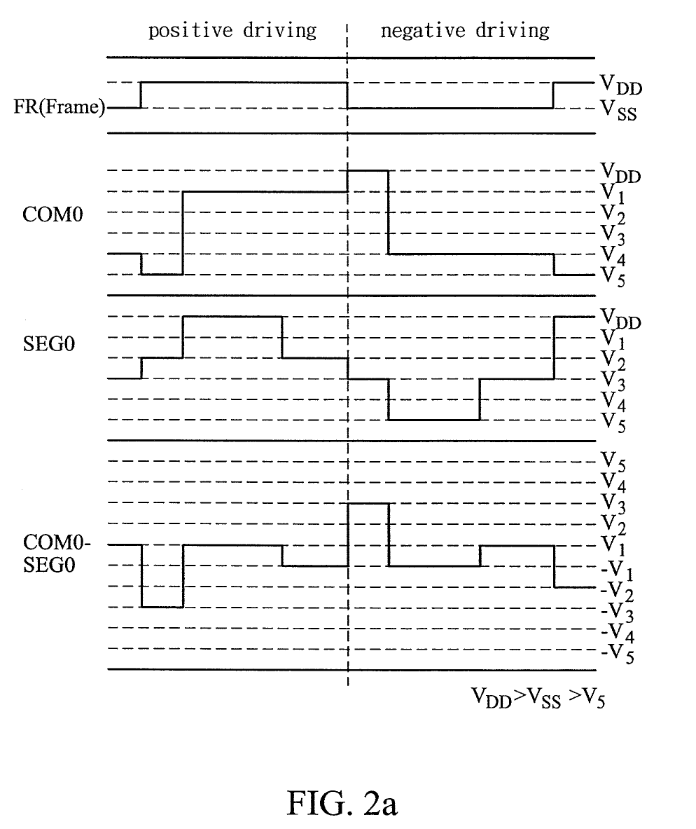

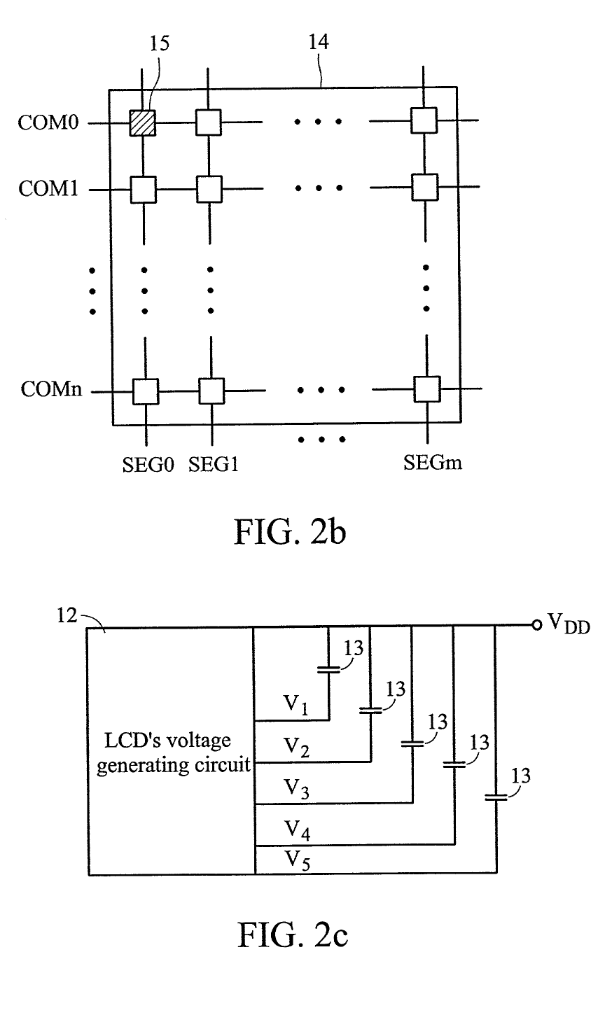

FIG. 1 is a block diagram of a control circuit for preventing residual image in an LCD in accordance with the embodiment of the present invention. The LCD (not shown) is a super twist nematic (STN) type LCD and the control circuit of the present invention includes a detection circuit 1, a comparator 3, a sub-control circuit 5, and a discharge circuit 11 .

First, two signals are input to the detection circuit 1 such as an “or” gate. One is a power down (PD) signal 2 and the other is a startup signal 4. They represent the state of the LCD's voltage generating circuit 12 and the state of the driving voltage (V₁, V₂, V₃, V₄, and V₅) (not shown). When the voltage generating circuit 12 is turned off (i.e. PD signal 2: high) or driving voltage is not built (i.e. startup signal 4: high), the present invention does not work. It prevents the LCD's voltage generating circuit 12 from consuming power during operation. On the other hand, when the voltage generating circuit 12 is turned on (i.e. PD signal 2: low) and the driving voltage (V₁, V₂, V₃, V₄, and V₅) is built (i.e. startup signal 4: low), the detection circuit 1 outputs an enable signal S₁ to the comparator 3 and sub-control circuit 5.

Next, the positive input of the comparator 3 inputs a reference voltage 6 and the negative input of the comparator 3 inputs a threshold voltage (e.g. V_{SS}) 8. This reference voltage 6 level changes with the source voltage V_{DD} (not shown), but the voltage difference between the source voltage and the reference voltage 6 is a constant (e.g. 2.1 V) . When the source voltage drops and the threshold voltage 8 (i.e. 0 V) is lower than the reference voltage 6 level during operation (e.g. source voltage: 2.4 V, reference voltage 6: 0.3 V), the discharge circuit 11 does not work. After the comparator 3 receives the enable signal Si, the comparator 3 compares the reference voltage 6 and the threshold voltage 8 (e.g. ground voltage). Since the reference voltage 6 changes with source voltage, when the LCD is turned off and the ground voltage 8 is higher than the reference voltage 6 level (e.g. source voltage: 2.0 V, reference voltage 6: −0.1 V), the comparator 3 outputs a data signal S₂ to the sub-control circuit 5.

Subsequently, after the sub-control circuit 5 coupled between the detection circuit 1 and the comparator 3 receives enable signal S₁ and data signal S₂, it outputs a control signal C₁ to the discharge circuit 11. In the embodiment, the sub-control circuit 5 is a one-shot circuit. It can prevent interference from the comparator 3 when the sub-control circuit 5 receives the signals.

Finally, the discharge circuit 11 is coupled between the one-shot circuit 5 and the LCD's voltage generating circuit 12, thereby receiving the control signal C, and shifting its voltage level. Then the discharge circuit 11 provides a discharge path to release the charge from the stable state cpaacitors (not shown) in the LCD Is voltage generating circuit 12. The discharge circuit 11 of the present invention includes a voltage level shifter 7 and a switch 9. The switch 9 is coupled between the voltage level shifter 7 and the LCD's voltage generating circuit 12. One terminal of the switch 9 is connected to the ground to provide a discharge path to release the charge stored in the stable capacitors as mentioned above. Since the control signal C₁ is a low voltage signal such as 3.3 volts and the LCD's voltage generating circuit 12 is a high voltage circuit such as 10 volts, it needs to shift the control signal C₁by the voltage level shift 7 to turn on the switch 9, releasing the charge.

To summarize, the present invention provides a method for preventing power off residual image in an LCD, including the following steps: outputting an enable signal S₁ to a comparator 3 and a sub-control circuit 5 by a detection circuit 1 when an LCD's voltage generating circuit 12 is turned on and the driving voltage of the circuit is built; outputting a data signal S₂ to the one-shot circuit 5 when a reference voltage 6 in the comparator 3 is lower than a ground voltage 8 in the comparator 3; outputting a control signal C₁ to a voltage level shifter 7 after receiving the enable signal S₁ and the data signal S₂ by the one-shot circuit 5; and releasing the charge stored in the at least one stable state capacitor of the LCD's voltage generating circuit 12 by a discharge path of the discharge circuit 11 that is coupled to the LCD's voltage generating circuit 12, thus preventing power off residual image in the LCD.

Although the invention has been described in its preferred embodiment, it is not intended to limit the invention to the precise embodiment disclosed herein. Those who are skilled in this technology can still make various alterations and modifications without departing from the scope and spirit of this invention. Therefore, the scope of the invention shall be defined and protected by following claims and their equivalents.

What is claimed is:

1. An LCD power-off control circuit for preventing residual image, comprising:
a detection circuit for detecting an LCD's voltage generating circuit, when the circuit is turned on and the driving voltage of the circuit is built, outputting an enable signal;
a comparator for inputting a reference voltage and a threshold voltage and receiving the enable signal to compare the reference voltage with the voltage, when the reference voltage is lower than the voltage, outputting a data signal;
a sub-control circuit for receiving the enable signal and the data signal and then outputting a control signal; and
a discharge circuit for receiving the control signal to shift the voltage level, and then providing a discharge path to release the charge stored in the at least one stable state capacitor of the LCD's voltage generating circuit.

2. The LCD power-off control circuit for preventing residual image in claim 1, wherein the discharge circuit further comprises:
a switch connecting one terminal to the ground to provide a discharge path to release the charge in the stable state capacitor; and
a voltage level shifter for shifting the control signal from the sub-control circuit to turn the switch on/off.

3. The LCD power-off control circuit for preventing residual image in claim 1, wherein the detection circuit is an “or” gate.

4. The LCD power-off control circuit for preventing residual image in claim 1, wherein the threshold voltage is ground voltage.

5. The LCD power-off control circuit for preventing residual image in claim 1, wherein the sub-control circuit is a one-shot circuit.

6. The LCD power-off control circuit for preventing residual image in claim 1, wherein the LCD is an STN type LCD.

7. An LCD power-off method for preventing residual image, comprising the steps:
outputting an enable signal to a comparator and a sub-control circuit by a detection circuit when an LCD's voltage generating circuit is turned on and the driving voltage of the circuit is built;
outputting a data signal to the sub-control circuit when a reference voltage in the comparator is lower than a threshold voltage in the comparator;
outputting a control signal to a discharge circuit after receiving the enable signal and the data signal by the sub-control circuit; and
releasing the charge stored in the at least one stable state capacitor of the LCD's voltage generating circuit by a discharge path of the discharge circuit that is coupled to the LCD's voltage generating circuit so as to eliminate residual image in the LCD.

8. The LCD power-off method for preventing residual image in claim 7, wherein the discharge circuit further comprises:
a switch connecting one terminal to the ground to provide a discharge path to release the charge in the stable state capacitor; and
a voltage level shifter for shifting the control signal from the sub-control circuit to turn the switch on/off.

9. The LCD power-off method for eliminating residual image in claim 8, wherein the detection circuit is an “or” gate.

10. The LCD power-off method for eliminating residual image in claim 8, wherein the sub-control circuit is a one-shot circuit.
